(19) United States
(12) Patent Application Publication
(10) Pub. No.: US 2018/0010562 A1
(43) Pub. Date: Jan. 11, 2018

(54) HIGH-PRESSURE PUMP AND METHOD FOR MANUFACTURING SAME

(71) Applicant: DENSO CORPORATION, Kariya-city, Aichi-pref. (JP)

(72) Inventors: Shinobu OIKAWA, Kariya-city (JP); Masaharu NAKAOKA, Kariya-city (JP)

(21) Appl. No.: 15/544,039

(22) PCT Filed: Jan. 13, 2016
(86) PCT No.: PCT/JP2016/000130

§ 371 Date: Jul. 17, 2017

(30) Foreign Application Priority Data
Jan. 20, 2015 (JP) 2015-8336

(51) Int. Cl. F02M 59/36; F02M 59/48; F02M 59/44; F02M 59/10; F04B 1/04; F02M 59/46

(52) U.S. Cl. CPC F02M 59/365; F02M 59/447; F02M 59/366; F02M 59/102; F02M 59/48; F02M 59/466; F02M 59/442; F04B 1/0456

(57) ABSTRACT

A plunger of a high-pressure pump is provided reciprocatably on an inner side of a cylinder. A holder disposed on an opposite side of the cylinder from a pressurizing chamber includes a large tubular portion that provides a predetermined space between the large tubular portion and an outer wall of the plunger, and a small tubular portion that is disposed on an opposite side of the large tubular portion from the cylinder. A pin inserted into a hole of the plunger at a position corresponding to the large tubular portion protrudes radially outward from the outer wall of the plunger and is accommodated in a space on an inner side of the large tubular portion.

### CROSS REFERENCE TO RELATED APPLICATION

This application is based on and incorporates herein by reference Japanese Patent Application No. 2015-008336 filed on Jan. 20, 2015.

### TECHNICAL FIELD

The present disclosure relates to a high-pressure pump for use in an internal combustion engine and to a method for manufacturing the high-pressure pump.

### BACKGROUND ART

Up to now, a high-pressure pump has been known, which is installed in a fuel supply system supplying a fuel to an internal combustion engine and pressurizes the fuel. The high-pressure pump varies a volume of a pressurizing chamber provided in an end portion of a cylinder by reciprocation of a plunger disposed inside the cylinder, and pressurizes the fuel. The fuel pressurized in the pressurizing chamber is discharged from a discharge passage communicating with the pressurizing chamber.

In one embodiment of a high-pressure pump disclosed in Patent Document 1, a ring-shaped member is fitted to a radially outer side of a plunger exposed in a pressurizing chamber. The high-pressure pump prevents the plunger from falling out of a cylinder by the ring-shaped member being engaged with a stepped portion between the pressurizing chamber and the cylinder before the high-pressure pump is attached to an internal combustion engine.

Further, in another embodiment of the high-pressure pump disclosed in Patent Document 1, an outer diameter of a plunger protruding on an opposite side of a cylinder from a pressurizing chamber is set to be smaller than an outer diameter of the plunger located inside the cylinder, and the plunger has a step at a location where the outer diameter of the plunger changes. The high-pressure pump also prevents the plunger from falling out of the cylinder by the step of the plunger being engaged with a stepped portion of a pump body before the high-pressure pump is attached to the internal combustion engine.

In the high-pressure pump disclosed in Patent Document 1, an intake valve unit for controlling the supply of a fuel to the pressurizing chamber is disposed on an opposite side of the pressurizing chamber from the plunger. The intake valve unit is detachably provided to the pump body. Therefore, in a configuration of the high-pressure pump, the plunger can be inserted into the cylinder from the pressurizing chamber side before the intake valve unit is attached to the pump body.

### PRIOR ART DOCUMENT

### Patent Document

Patent Document 1: JP 2003-065175 A

### SUMMARY

In the high-pressure pump disclosed in Patent Document 1, there is a case where a body size of the cylinder in an axial direction of the cylinder is increased by the above-described intake valve unit. If a position of the intake valve unit is changed in the radial direction of the cylinder, and the opposite side of the pressurizing chamber from the plunger is closed with the pump body in the high-pressure pump disclosed in Patent Document 1, it is difficult to attach the plunger of any embodiments to the cylinder from an opening located on an opposite side of the cylinder from the pressurizing chamber.

The present disclosure is made in view of the above-described points, and it is an object of the present invention to provide a high-pressure pump and a method for manufacturing the high-pressure pump, which are capable of preventing a plunger from falling off regardless of an attaching direction of the plunger to a cylinder.

According a first aspect of the present disclosure, a high-pressure pump includes: a cylinder; a pump body that includes a pressurizing chamber provided in an end portion of the cylinder; a plunger that is disposed reciprocatably on an inner side of the cylinder and is capable of changing a volume of the pressurizing chamber; a cylindrical member that is disposed coaxially with the cylinder on an opposite side of the cylinder from the pressurizing chamber, and the cylindrical member including a large tubular portion which defines a predetermined space between the large tubular portion and an outer wall of the plunger, and a small tubular portion having an inner diameter smaller than an inner diameter of the large tubular portion and being located on an opposite side of the large tubular portion from the cylinder; and a locking member protruding radially outward from the outer wall of the plunger at a position corresponding to the large tubular portion of the cylindrical member, the locking member being accommodated in the space on an inner side of the large tubular portion.

As a result, the locking member is engaged with the stepped portion between the large tubular portion and the small tubular portion of the cylindrical member before the high-pressure pump is attached to the internal combustion engine. Thus, the plunger can be prevented from falling out of the cylinder.

According a second aspect of the present disclosure, a method for manufacturing the high-pressure pump includes: a step of placing the plunger on an inner side of a cylindrical jig, and placing the locking member within a hole or a groove provided on the outer wall of the plunger; a step of inserting the jig into the large tubular portion of the cylindrical member; and a step of detaching the jig from the plunger, and protruding the locking member from the outer wall of the plunger toward the large tubular portion of the cylindrical member.

According to a third aspect of the present disclosure, a method for manufacturing the high-pressure pump includes: a step of fitting the locking member into a space inside the large tubular portion in a direction from an opposite side of the cylindrical member from the small tubular portion; a step of inserting the plunger into the cylinder; and a step of fixing the cylindrical member to the pump body.

In the manufacturing method according to the second and third aspects, even if the high-pressure pump has a shape in which the opposite side of the pressurizing chamber from the plunger is closed by the pump body, the locking member can be installed on the inner side of the large tubular portion of the cylindrical member.

### BRIEF DESCRIPTION OF THE DRAWINGS

FIG. 1 is a cross-sectional view illustrating a high-pressure pump according to a first embodiment of the present disclosure.

FIG. 2 is a diagram illustrating a portion II in FIG. 1.

FIG. 3 is a cross-sectional view illustrating a part of a high-pressure pump before being attached to an internal combustion engine according to the first embodiment.

FIG. 4 is a flowchart illustrating a manufacturing process of the high-pressure pump according to the first embodiment.

FIG. 5 is a cross-sectional view illustrating a state of the high-pressure pump at the time of manufacturing the high-pressure pump according to the first embodiment.

FIG. 6 is a cross-sectional view taken along a line VI-VI of FIG. 5.

FIG. 7 is a cross-sectional view illustrating a state in which the high-pressure pump is attached to the internal combustion engine according to the first embodiment.

FIG. 8 is a flowchart illustrating another manufacturing process of the high-pressure pump according to the first embodiment.

FIG. 9 is a cross-sectional view illustrating a state of the high-pressure pump at the time of manufacturing the high-pressure pump according to the first embodiment.

FIG. 10 is a cross-sectional view illustrating a state in which the high-pressure pump is attached to the internal combustion engine in a first comparative example of the present disclosure.

FIG. 11 is a cross-sectional view illustrating a state in which the high-pressure pump is attached to the internal combustion engine in a second comparative example of the present disclosure.

FIG. 12 is a cross-sectional view illustrating a part of a high-pressure pump according to a second embodiment of the present disclosure.

FIG. 13 is a cross-sectional view taken along a line XIII-XIII in FIG. 12.

FIG. 14 is a cross-sectional view illustrating a part of a high-pressure pump according to a third embodiment of the present disclosure.

FIG. 15 is a flowchart illustrating a manufacturing process of the high-pressure pump according to the third embodiment.

FIG. 16 is a cross-sectional view illustrating a state of the high-pressure pump at the time of manufacturing the high-pressure pump according to the third embodiment.

FIG. 17 is a cross-sectional view illustrating a state of the high-pressure pump at the time of manufacturing the high-pressure pump according to the third embodiment.

FIG. 18 is a partially cross-sectional view illustrating a high-pressure pump according to a fourth embodiment of the present disclosure.

FIG. 19 is a cross-sectional view illustrating a state of the high-pressure pump at the time of manufacturing the high-pressure pump according to the fourth embodiment.

### DESCRIPTION OF EMBODIMENTS

Hereinafter, multiple embodiments for implementing the present invention will be described referring to drawings. In the respective embodiments, a part that corresponds to a matter described in a preceding embodiment may be assigned the same reference numeral, and redundant explanation for the part may be omitted. When only a part of a configuration is described in an embodiment, another preceding embodiment may be applied to the other parts of the configuration. The parts may be combined even if it is not explicitly described that the parts can be combined. The embodiments may be partially combined even if it is not explicitly described that the embodiments can be combined, provided there is no harm in the combination.

### First Embodiment

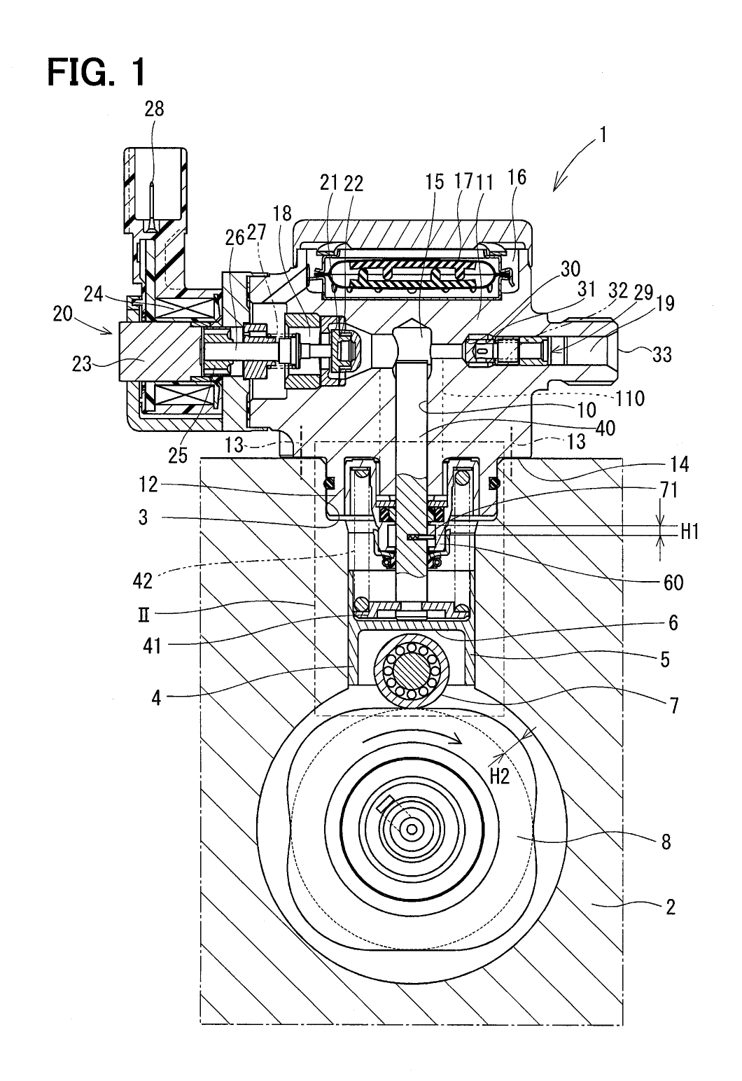

A high-pressure pump according to a first embodiment of the present disclosure is illustrated in FIGS. 1 to 9. A high-pressure pump 1 according to the present embodiment is attached to an engine block 2 of an internal combustion engine, pressurizes a fuel pumped up from a fuel tank, and pumps the pressurized fuel to a delivery pipe. The fuel accumulated in the delivery pipe is injected and supplied from an injector to each cylinder of the internal combustion engine.

As illustrated in FIG. 1, the high-pressure pump 1 includes a cylinder 10, a pump body 11, a plunger 40, a holder 60 as a cylindrical member, a pin 71 as a locking member, and the like. In FIG. 1, a boundary between the cylinder 10 and the pump body 11 is conceptually indicated by a dashed line 110, but in the present embodiment, the cylinder 10 and the pump body 11 are integrated with each other seamlessly. The cylinder 10 and the pump body 11 may be formed as separate members. The pump body 11 has a cylindrical fitting portion 12 that can be fitted to a bore 3 formed in the engine block 2 of the internal combustion engine. The pump body 11 is fixed to the engine block 2 by a bolt not shown disposed at a position indicated by a dash dotted line 13 in FIG. 1. In that situation, an abutment surface 14 provided on an outer side of the fitting portion 12 abuts against the engine block 2.

The pump body 11 has a pressurizing chamber 15 formed at a deep portion (end portion) of the cylinder 10. An inner diameter of the pressurizing chamber 15 is set to be slightly larger than an inner diameter of the cylinder 10. The pressurizing chamber 15 is closed by the pump body 11 on a side opposite to the plunger 40. In the pump body 11, a damper chamber 16 is formed on a side of the pressurizing chamber 15 opposite to the cylinder 10. A pulsation damper 17 is disposed in the damper chamber 16. In the pulsation damper 17, gas of a predetermined pressure is sealed on the inner side of two metal diaphragms, and the two metal diaphragms are elastically deformed according to a pressure change of the damper chamber 16, to thereby reduce the fuel pressure pulsation of the damper chamber 16.

The pump body 11 includes a supply passage 18 and a discharge passage 19 which extend in a radial direction of the cylinder 10 from the pressurizing chamber 15. An intake valve unit 20 is disposed in the supply passage 18. The intake valve unit 20 communicates or blocks between the pressurizing chamber 15 and the supply passage 18 by separating or seating an intake valve 22 from or on a valve seat 21 provided in the supply passage 18. The intake valve 22 is driven and controlled by an electromagnetic drive portion. The electromagnetic drive portion is configured by a fixed core 23, a coil 24, a movable core 25, a shaft 26, a spring 27, and the like. The intake valve 22 of the present embodiment is of a normally open type, and when the coil 24 is energized from a connector terminal 28, the movable core 25 is magnetically attracted toward the fixed core 23 against the urging force of the spring 27, and an urging force of the shaft 26 for urging the intake valve 22 in the valve opening direction is released.

A discharge valve unit 29 is disposed in the discharge passage 19. The discharge valve unit 29 communicates or blocks between the pressurizing chamber 15 and the discharge passage 19 by separating or seating a discharge valve 31 from or on a valve seat 30 provided in the discharge passage 19. When the fuel pressure from the pressurizing chamber 15 to the discharge valve 31 becomes larger than a sum of a force received by the discharge valve 31 from the fuel on a downstream side of the valve seat 30 and an elastic force of a spring 32, the discharge valve 31 separates from the valve seat 30. As a result, the fuel is discharged from a fuel outlet 33 through the pressurizing chamber 15 and the discharge passage 19.

The plunger 40 is accommodated on the inner side of the cylinder 10 formed cylindrically so as to be reciprocatable in the axial direction. The plunger 40 moves toward the damper chamber 16 to reduce a volume of the pressurizing chamber 15 and pressurizes the fuel. Further, the plunger 40 moves to a side opposite to the damper chamber 16, thereby increasing the volume of the pressurizing chamber 15 and sucking the fuel from the supply passage 18 to the pressurizing chamber 15.

A spring seat 41 is fixed to an end portion of the plunger 40 opposite to the pressurizing chamber 15. A plunger spring 42 is installed between the spring seat 41 and the holder 60 fixed to the pump body 11. The plunger spring 42 urges the plunger 40 together with the spring seat 41 toward a direction opposite to the pressurizing chamber 15. The spring seat 41 is fitted to a lifter 4 which is put in the bore 3 of the internal combustion engine.

The lifter 4 includes a tubular portion 5 having a cylindrical shape, a partition plate 6 that is disposed in a middle portion of the tubular portion 5 in the axial direction, and a roller 7 that is disposed on an opposite side of the spring seat 41 across the partition plate 6. The outer wall of the tubular portion 5 comes in sliding contact with an inner wall of the bore 3 of the internal combustion engine. The roller 7 comes in sliding contact with a cam 8 disposed at a deep portion of the bore 3 of the internal combustion engine. The cam 8 rotates together with a camshaft or a crankshaft driving intake and exhaust valves of the internal combustion engine. With the rotation of the cam 8, the lifter 4 reciprocates on the inner side of the bore 3, and accordingly, the plunger 40 that abuts against the partition plate 6 of the lifter 4 reciprocates in the cylinder 10 in the axial direction.

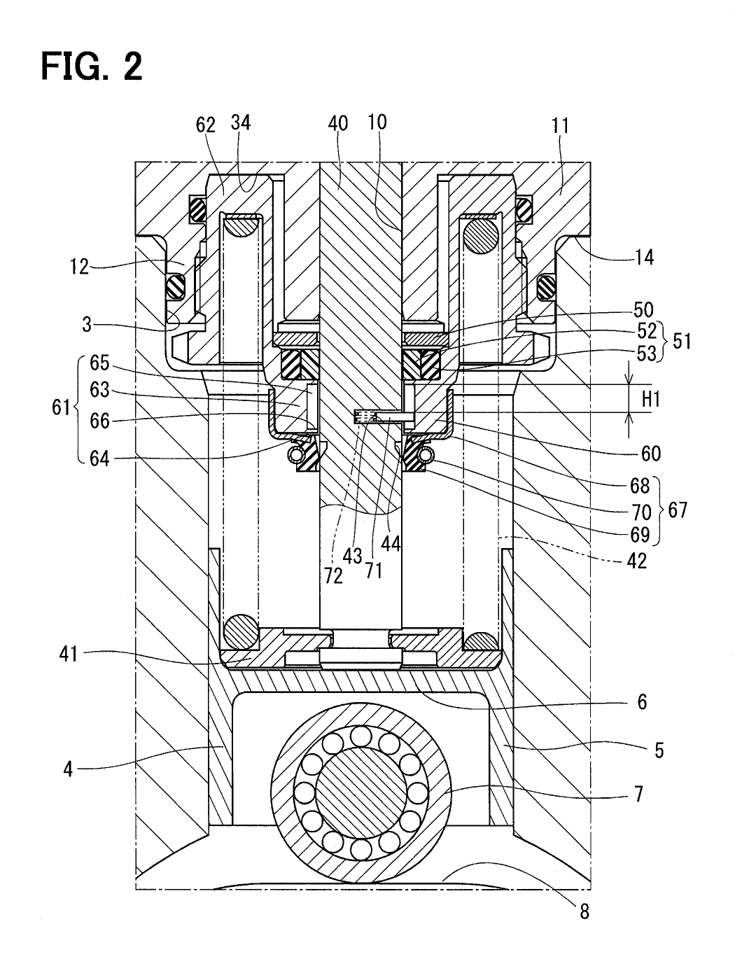

As illustrated in FIG. 2, an annular spacer 50 is disposed at an end portion of the cylinder 10 opposite to the pressurizing chamber 15 (refer to FIG. 1). A fuel seal 51 is disposed on a side of the spacer 50 opposite to the pressurizing chamber 15. The fuel seal 51 is configured by a ring member 52 made of fluororesin and an O-ring 53 provided on the radially outer side of the ring member 52. The fuel seal 51 regulates a thickness of a fuel oil film around the plunger 40 and suppresses a fuel leakage to the internal combustion engine caused by sliding of the plunger 40.

A holder 60 is disposed on a side of the fuel seal 51 opposite to the pressurizing chamber 15. The holder 60 is disposed axially with the cylinder 10 on the radially outer side of the plunger 40. The holder 60 includes a holder main body 61 formed in a cylindrical shape and a spring receiving portion 62 disposed on the radially outer side of the holder main body 61. The spring receiving portion 62 extends from the radially outer side of the holder main body 61 toward the pump body 11 and is fixed to a concave portion 34 provided in the pump body 11 around the cylinder 10. The holder 60 according to the present embodiment corresponds to an example of a cylindrical member provided coaxially with the cylinder 10 on a side of the cylinder 10 opposite to the pressurizing chamber 15.

The holder main body 61 includes a large tubular portion 63 and a small tubular portion 64. A cylindrical space 65 is provided between the large tubular portion 63 and the plunger 40. The small tubular portion 64 is disposed on the side of the large tubular portion 63 opposite to the cylinder 10 and has an inner diameter smaller than that of the large tubular portion 63. For that reason, a stepped surface 66 is provided between the large tubular portion 63 and the small tubular portion 64.

An oil seal 67 is installed to an end portion of the holder 60 opposite to the pressurizing chamber 15. The oil seal 67 includes an annular plate member 68 fixed on the outer side of the holder main body 61, an annular sealing member 69 for molding the plate member 68, and an annular coil spring 70 disposed on a radially outer side of the sealing member 69. The coil spring 70 according to the present embodiment corresponds to an example of an annular second urging device that urges the sealing member 69 radially inward. The coil spring 70 urges the sealing member 69 radially inward. The oil seal 67 regulates a thickness of an oil film around the plunger 40 and suppresses an entry of the oil from the internal combustion engine side due to sliding of the plunger 40.

A hole 43 is provided on the outer wall of the plunger 40 at a position corresponding to the large tubular portion 63 of the holder 60. The columnar pin 71 and a small spring 72 are accommodated in the hole 43. The small spring 72 according to the present embodiment corresponds to an example of an urging device that urges the pin 71 from the hole 43 of the plunger 40 toward the large tubular portion 63 of a cylindrical member. Further, the pin 71 and the small spring 72 according to the present embodiment protrude radially outward from the outer wall of the plunger 40, and correspond to an example of a locking member accommodated in the space 65 on the inner side of the large tubular portion 63.

The small spring 72 urges the pin 71 from the hole 43 of the plunger 40 toward the large tubular portion 63 of the holder 60. For that reason, the pin 71 protrudes radially outward from the outer wall of the plunger 40 by the aid of an urging force of the small spring 72, and is accommodated in the space 65 on the inner side of the large tubular portion 63. It should be noted that a length of the pin 71 has the degree that enables the entire pin 71 to be accommodated within the hole 43 of the plunger 40 when the small spring 72 is compressed.

FIG. 2 illustrates a state in which the plunger 40 is located at a bottom dead center while the high-pressure pump 1 is attached to the internal combustion engine. In this state, a distance H1 between an inner wall of the large tubular portion 63 behind the cylinder 10 and the pin 71 is larger than a distance (refer to a height H2 of a nose of the cam 8 in FIG. 1) in which the plunger 40 reciprocates. In other words, even when the plunger 40 is located at the top dead center, an inner wall of the large tubular portion 63 on the cylinder 10 side comes out of contact with the pin 71.

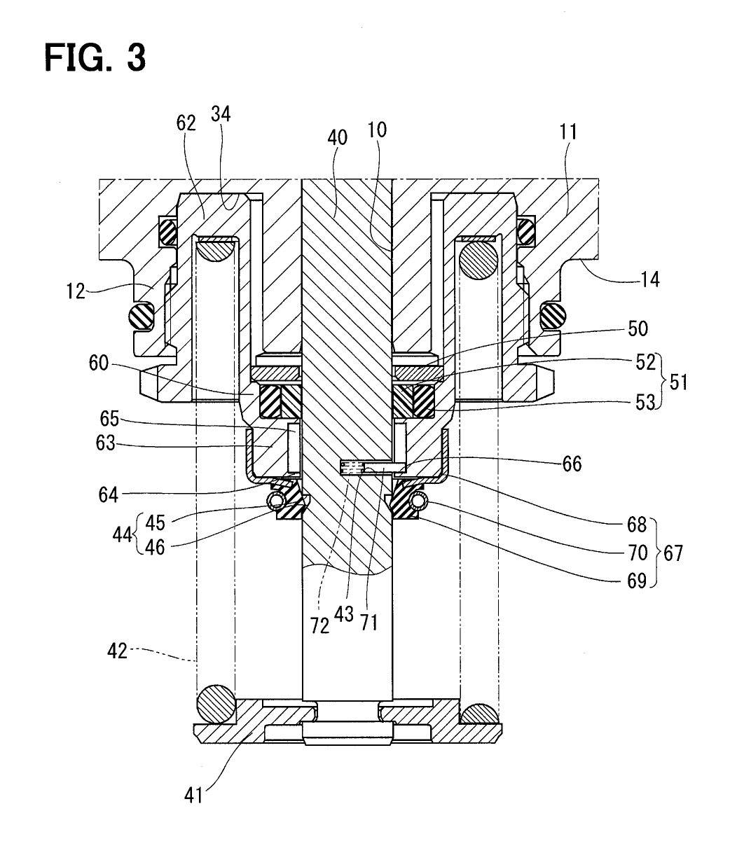

FIG. 3 illustrates a state of the high-pressure pump 1 before being attached to the internal combustion engine. In that state, the plunger 40 is urged to a side opposite to the pressurizing chamber 15 by the aid of an urging force of the plunger spring 42. At that time, one end of the pin 71 disposed in the hole 43 of the plunger 40 is locked to the stepped surface 66 between the large tubular portion 63 and the small tubular portion 64 of the holder 60. For that reason, the plunger 40 is prevented from falling out of the cylinder 10, and the plunger spring 42 is held in a compressed state.

Further, in that state, the sealing member 69 configuring the oil seal 67 is fitted into a groove portion 44 formed in the plunger 40 by the aid of the urging force of the coil spring 70 disposed on the outer side of the sealing member 69. The groove portion 44 of the plunger 40 has an end face 45 facing an opposite direction from the pressurizing chamber 15, and the end face 45 is perpendicular to an axis of the plunger 40. For that reason, since the sealing member 69 hardly moves beyond the end face 45, the movement of the plunger 40 toward the side opposite to the pressurizing chamber 15 is suppressed, as a result of which the falling off of the plunger 40 is suppressed.

The groove portion 44 of the plunger 40 has a tapered surface 46 on the side opposite to the pressurizing chamber 15. With this configuration, since the sealing member 69 easily moves beyond the tapered surface 46, the plunger 40 can be easily moved to the pressurizing chamber 15 side, as a result of which, attachment of the pump body 11 to the engine block 2 is facilitated.

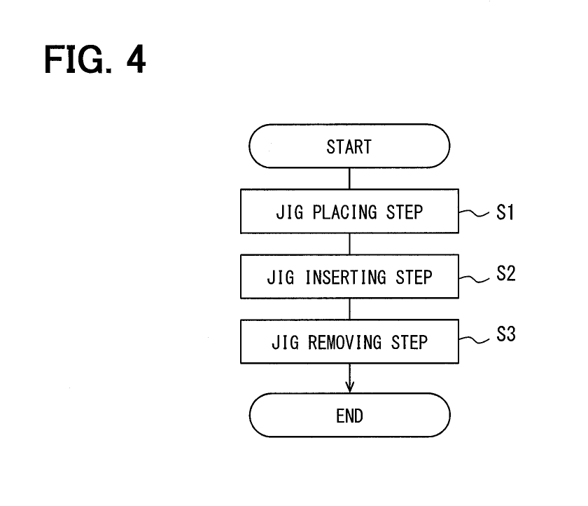

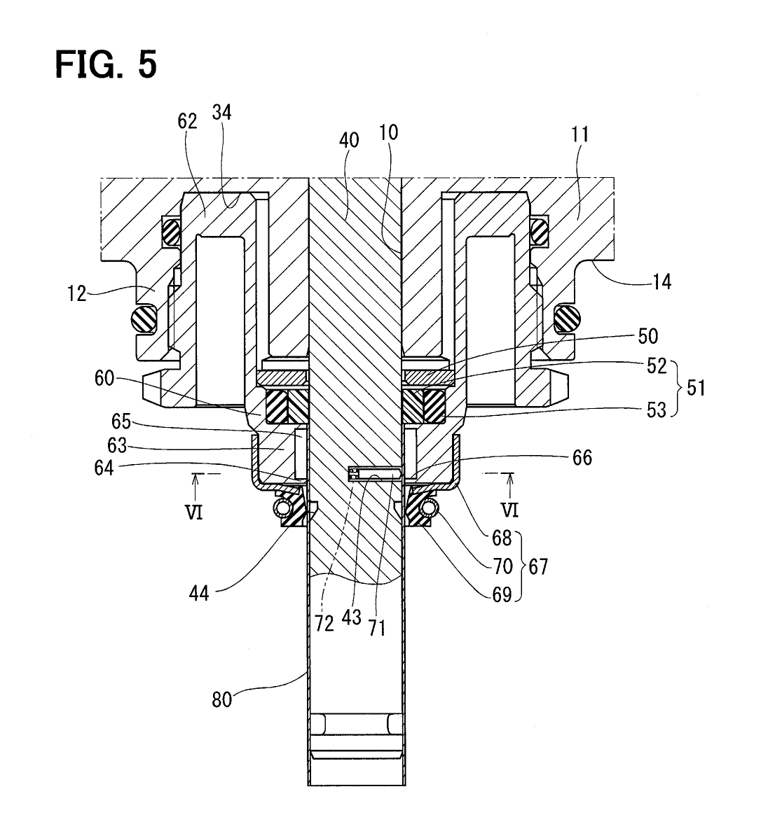

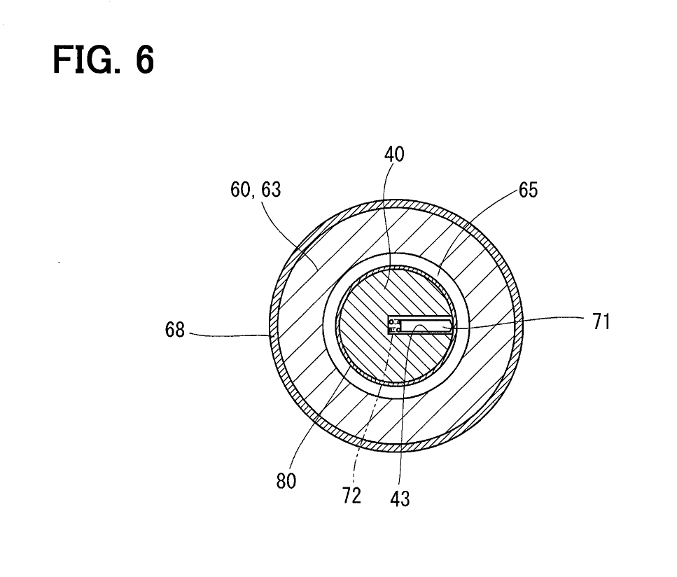

Next, a method for manufacturing the high-pressure pump 1 will be described with reference to FIGS. 4 to 7. In the flowcharts described in the drawings, each step is denoted by S. First, in a jig placing step of Step 1, the plunger 40 is accommodated on the inner side of a cylindrical jig 80. At this time, the pin 71 is accommodated in the hole 43 of the plunger 40 against the urging force of the small spring 72. Next, in a jig inserting step of Step 2, the plunger 40 is inserted into the cylinder 10 and the jig 80 is inserted into the large tubular portion 63 of the holder 60. At this time, as illustrated in FIGS. 5 and 6, the insertion amount of the plunger 40 is adjusted so that the pin 71 is positioned on the inner side of the large tubular portion 63. Subsequently, in a jig removing step of Step 3, the jig 80 is removed from the plunger 40. As a result, the pin 71 protrudes from the outer wall of the plunger 40 toward the large tubular portion 63 of the holder 60.

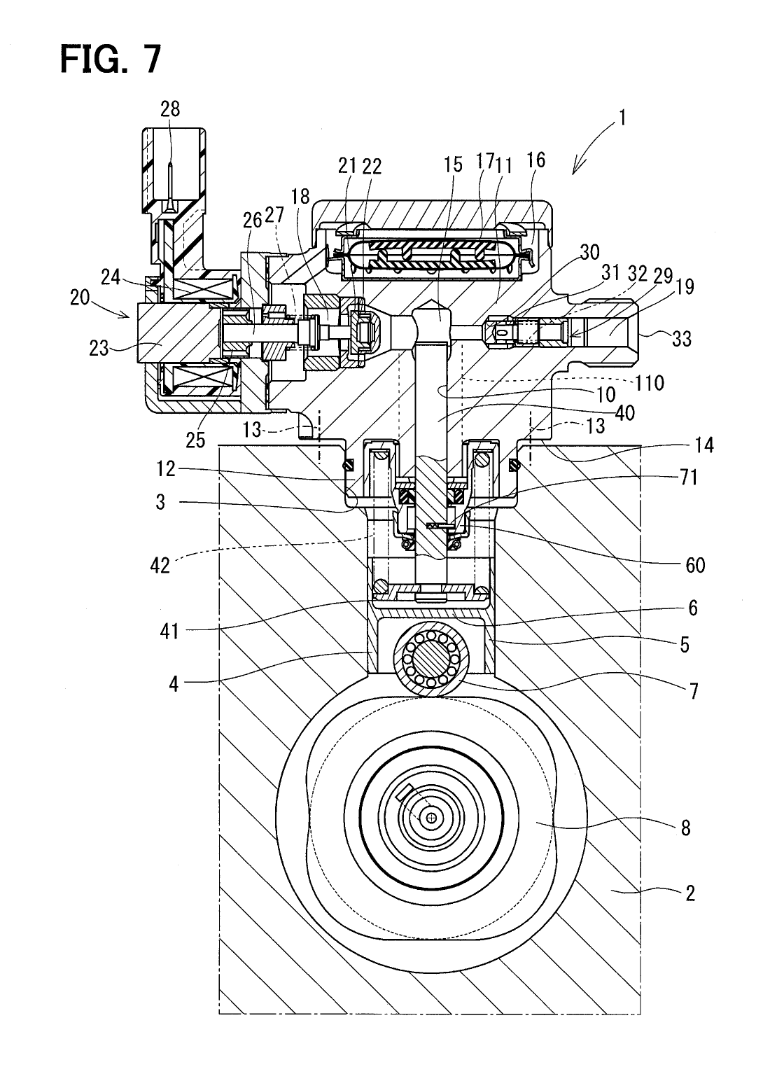

Thereafter, as illustrated in FIG. 7, the high-pressure pump 1 is attached to the bore 3 formed in the engine block 2 of the internal combustion engine. FIG. 7 illustrates a state before the pump body 11 is fastened to the engine block 2 with bolts 13. In this state, since the plunger spring 42 is compressed by a predetermined amount, the fitting portion 12 of the pump body 11 is fitted in the bore 3 of the engine block 2. Therefore, since the amount of compression of the plunger spring 42 at the time of fastening with the bolts is reduced, the pump body 11 can be easily fastened to the engine block 2 with bolts.

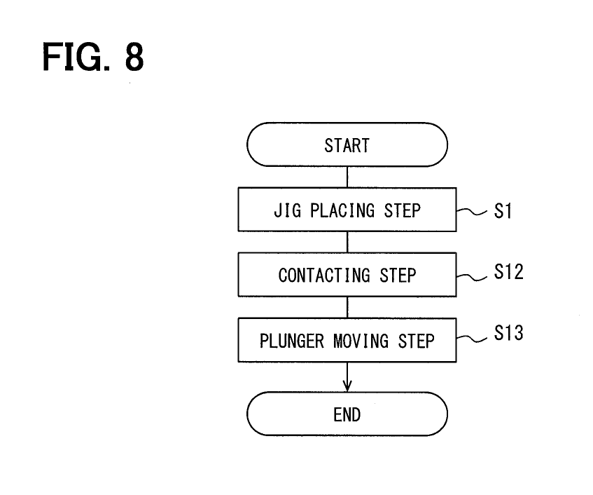

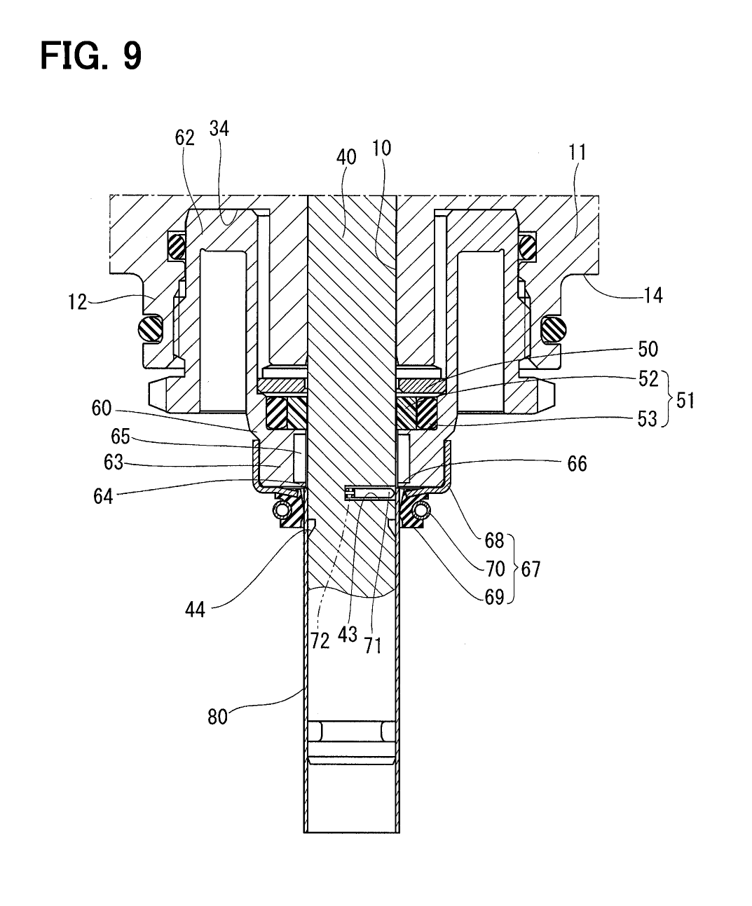

FIGS. 8 and 9 illustrate another manufacturing method of the high-pressure pump 1 according to the first embodiment. In the manufacturing method, Step 1 is the same as that described above. Next, in a contacting step of Step 12, the plunger 40 is inserted into the cylinder 10 and the jig 80 is brought into contact with the end portion of the holder 60 in the axial direction of the holder 60. In this situation, as illustrated in FIG. 9, the pin 71 is located on the side opposite to the pressurizing chamber 15 with respect to the holder 60. Subsequently, in a plunger moving step of Step 13, the plunger 40 is moved toward the pressurizing chamber 15. As a result, the pin 71 moves from the inner side of the jig 80 toward the holder 60, and the pin 71 protrudes from the outer wall of the plunger 40 toward the large tubular portion 63 of the holder 60. Thereafter, the high-pressure pump 1 is attached to the bore 3 formed in the engine block 2 as with the above-described process.

The high-pressure pump 1 according to the first embodiment has the following operational effects. (1) In the first embodiment, the pin 71 disposed at a position corresponding to the large tubular portion 63 of the holder 60 protrudes radially outward from the outer wall of the plunger 40 and is accommodated on the inner side of the large tubular portion 63.

As a result, since the pin 71 is locked to the stepped surface 66 between the large tubular portion 63 and the small tubular portion 64 of the holder 60 in a state before the high-pressure pump 1 is attached to the internal combustion engine, the plunger 40 is prevented from falling out of the cylinder 10. For that reason, the plunger spring 42 can be attached to the pump body 11 with the plunger spring 42 contracted by a predetermined amount. Therefore, when the high-pressure pump 1 is fastened to the internal combustion engine with bolts, since the length of further compressing the plunger spring 42 is shortened, the operation efficiency can be enhanced.

In addition, since the pin 71 is disposed on the inner side of the holder 60 disposed at a position distant from the pressurizing chamber 15, even if the pin 71 is broken, there is a low possibility that, in the high-pressure pump 1, a broken piece of the broken pin 71 and the like damage an inner wall of the cylinder 10.

(2) In the first embodiment, the pump body 11 closes the side of the pressurizing chamber 15 opposite to the plunger 40. As a result, the high-pressure pump 1 is configured so that the intake valve unit 20 for supplying a fuel to the pressurizing chamber 15 is not installed on the side of the pressurizing chamber 15 opposite to the plunger 40. For that reason, in the high-pressure pump 1, the body size of the cylinder 10 in the axial direction can be reduced.

(3) In the first embodiment, the pin 71 can be accommodated in the hole 43 provided in the outer wall of the plunger 40 and projects radially outward from the outer wall of the plunger 40 by the aid of the urging force of the small spring 72. As a result, even after the holder 60 has been attached to the pump body 11, the pin 71 can be installed on the inner side of the large tubular portion 63 of the holder 60.

(4) In the first embodiment, the high-pressure pump 1 is provided with the annular sealing member 69 provided on the radially outer side of the plunger 40 and the coil spring 70 for urging the sealing member 69 radially inward. The plunger 40 has the groove portion 44 into which the sealing member 69 can be fitted in a state before the high-pressure pump 1 is installed in the internal combustion engine or in a state where the high-pressure pump 1 has been installed. As a result, in a state before the high-pressure pump 1 is installed in the internal combustion engine, the plunger 40 can be prevented from falling out of the cylinder 10 by the aid of the urging force of the coil spring 70.

(5) In the first embodiment, the method of manufacturing the high-pressure pump 1 includes the jig placing step (S1), the jig inserting step (S2) and the jig removing step (S3) described above. As a result, even if the high-pressure pump 1 is shaped such that the opposite side of the pressurizing chamber 15 from the plunger 40 is closed by the pump body 11, the pin 71 can be installed on the inner side of the large tubular portion 63 of the holder 60. Further, when the high-pressure pump 1 is assembled, since the plunger 40 is inserted into the cylinder 10 from the opening on the side of the cylinder 10 opposite to the pressurizing chamber 15, there is no possibility that the inner wall of the cylinder 10 is damaged by the pin 71. Therefore, the high-pressure pump 1 can enhance a quality relating to the fuel discharge amount, the leakage amount, and the like.

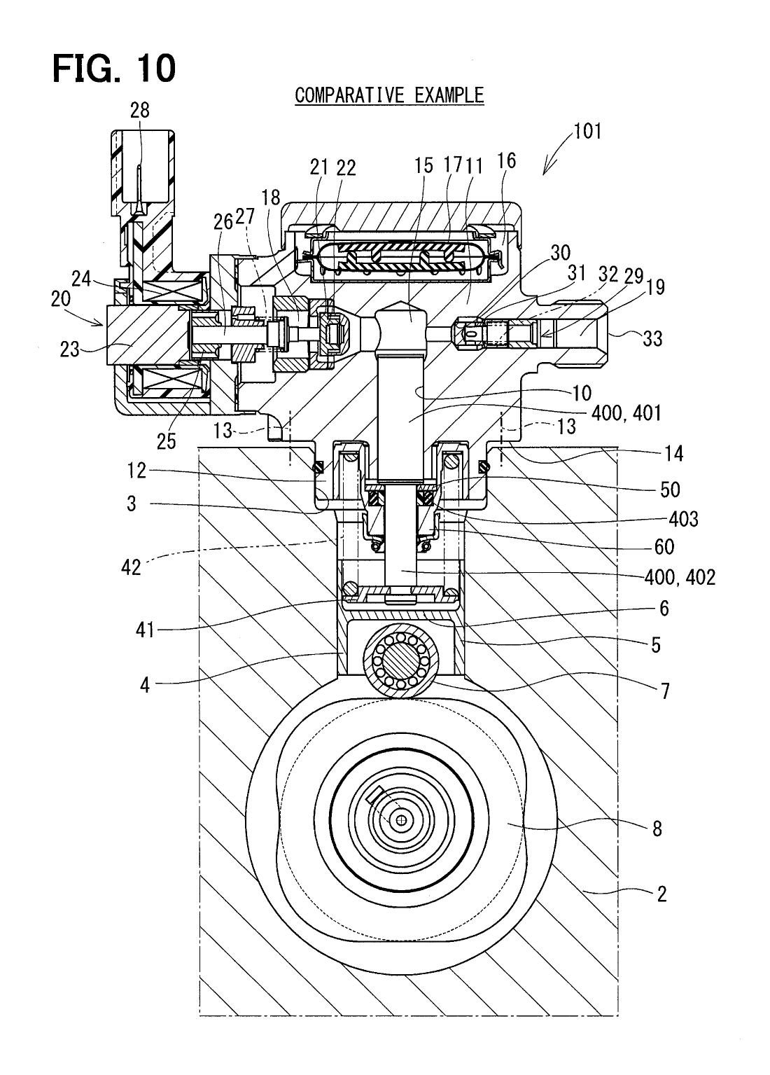

Now, a first comparative example will be described with reference to FIG. 10. In a high-pressure pump 101 according to the first comparative example, a plunger 400 includes a large-diameter large column portion 401 and a small column portion 402 having an outer diameter smaller than that of the large column portion 401. The large column portion 401 is inserted into a cylinder 10. The small column portion 402 protrudes to an opposite side of a pressurizing chamber 15 from the cylinder 10. The plunger 400 has a step 403 at a position where the large column portion 401 and the small column portion 402 are connected to each other. An annular spacer 50 provided at an end portion of the cylinder 10 opposite to the pressurizing chamber 15 has an inner diameter corresponding to the small column portion 402 of the plunger 400. For that reason, in a state of the high-pressure pump 101 according to the first comparative example before being attached to the internal combustion engine, the step 403 of the plunger 400 is locked to the spacer 50, thereby preventing the plunger 400 from falling out of the cylinder 10.

In general, when the plunger 400 reciprocates in the cylinder 10 due to the rotation of a cam 8, the high-pressure pump 101 may cause the plunger 400 to be misaligned in a rotational direction of the cam 8. In this case, in the high-pressure pump 101 according to the first comparative example, it is conceivable that a load acting on the inner wall of the cylinder 10 from the step 403 provided at a connection portion between the large column portion 401 and the small column portion 402 increases. For that reason, as compared with the plunger 40 according to the first embodiment, the high-pressure pump 101 in the first comparative example is concerned that a seizure resistance of the plunger 400 is lowered.

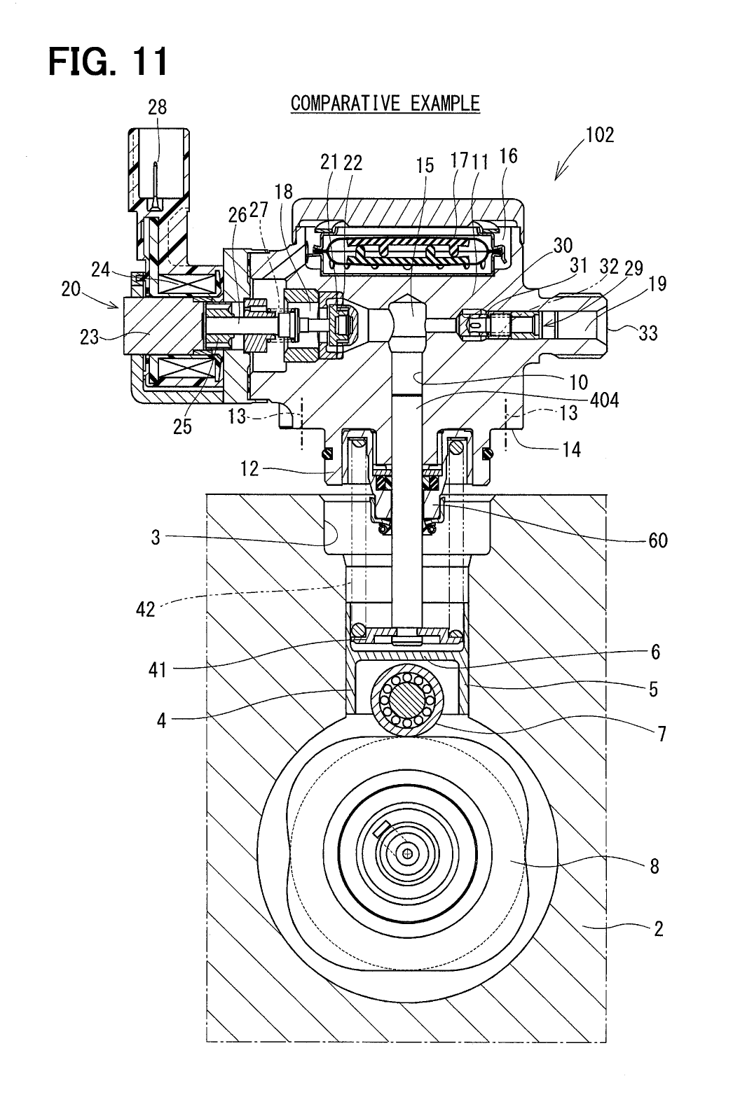

Next, a second comparative example will be described with reference to FIG. 11. As with the plunger 40 according to the first embodiment, a plunger 40 of a high-pressure pump 102 according to a second comparative example is a so-called straight plunger 404 having the same outer diameter in an axial direction. However, the high-pressure pump 102 according to the second comparative example has no configuration to prevent the straight plunger 404 from falling off. For that reason, when the high-pressure pump 102 is attached to a bore 3 of the internal combustion engine, since a plunger spring 42 extends to a free length, a pump body 11 is fastened with bolts from a state where a fitting portion 12 of the pump body 11 is not fitted in the bore 3. Therefore, in the high-pressure pump 102, since the operation of compressing the plunger spring 42 and fitting the fitting portion 12 of the pump body 11 to the bore 3 and the operation of fastening the pump body 11 to an engine block 2 with the bolts need to be performed at the same time, there is a possibility that workability may be deteriorated.

### Second Embodiment

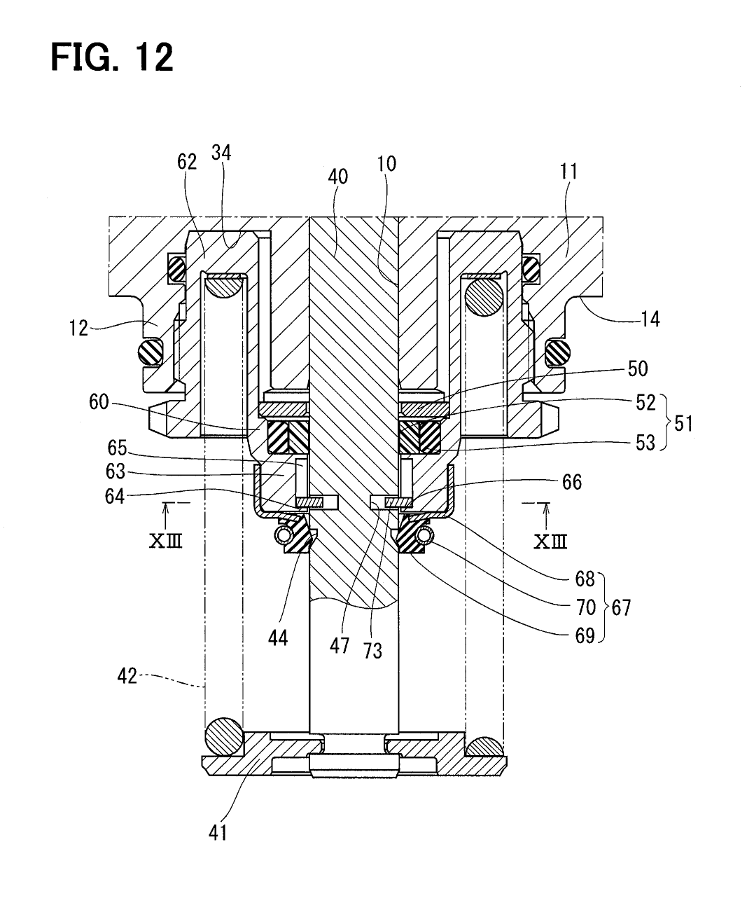

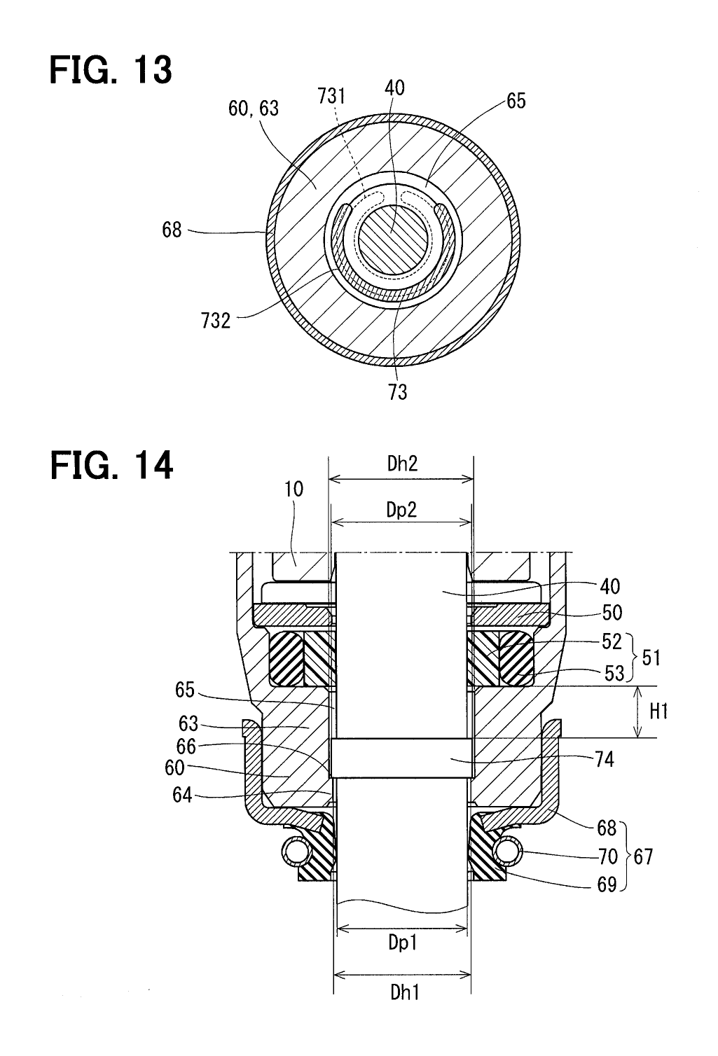

Subsequently, a second embodiment according to the present disclosure will be described with reference to FIGS. 12 and 13. In the second embodiment, an annular groove 47 is provided on an outer wall of a plunger 40 at a position corresponding to a large tubular portion 63 of a holder 60. A C ring 73 having an arc shape is accommodated in the groove 47. The C ring 73 according to the present embodiment corresponds to an example of an arc-shaped elastic member that can be accommodated within the groove 47 that has an annular shape and is provided on the outer wall of the plunger 40. Further, the C ring 73 according to the present embodiment corresponds to an example of the locking member described above.

As indicated by a broken line 731 in FIG. 13, the C ring 73 can be accommodated within the groove 47 of the plunger 40 in a state where the entirety of the C ring 73 is compressed in a radially inward direction. As illustrated by a solid line 732 in FIG. 13, the C ring 73 protrudes radially outward from the outer wall of the plunger 40 due to its own elasticity, and is accommodated so as to extend from the groove 47 to a space 65 on the inner side of the large tubular portion 63.

FIG. 12 illustrates a state of a high-pressure pump 1 before being attached to the internal combustion engine. In that state, the plunger 40 is urged to a side opposite to a pressurizing chamber 15 by the aid of an urging force of a plunger spring 42. In this situation, the outer peripheral side of the C ring 73 is locked to a stepped surface 66 between the large tubular portion 63 and a small tubular portion 64 of the holder 60. For that reason, the plunger 40 is prevented from falling out of a cylinder 10, and the plunger spring 42 is held in a compressed state. The second embodiment can also achieve the same operational effects as those in the first embodiment.

### Third Embodiment

A third embodiment of the present disclosure will be described with reference to FIGS. 14 to 17. In the third embodiment, a large tubular portion 63 of a holder 60 has an equal inner diameter from a small tubular portion 64 to a cylinder 10. For that reason, a space 65 on the inner side of the large tubular portion 63 is open toward the cylinder 10.

A plunger 40 is integrated with a large diameter portion 74 at a position corresponding to the large tubular portion 63 of the holder 60. An outer diameter of the large diameter portion 74 is larger than an outer diameter of the plunger 40.

The large diameter portion 74 and the plunger 40 are seamlessly integrated with each other. The large diameter portion 74 of the present embodiment corresponds to an example of the above mentioned locking member.

In this case, it is assumed that an outer diameter of the plunger 40 is Dp1, an outer diameter of the large diameter portion 74 is Dp2, an inner diameter of the large tubular portion 63 of the holder 60 is Dh2, and an inner diameter of the small tubular portion 64 of the holder 60 is Dh1. In this case, a relationship of those diameters is Dh2>Dp2>Dh1>Dp1. Therefore, in a state of a high-pressure pump 1 before being attached to the internal combustion engine, the large diameter portion 74 is locked to a stepped surface 66 between the large tubular portion 63 and the small tubular portion 64. For that reason, the plunger 40 is prevented from falling out of the cylinder 10, and a plunger spring 42 is held in a compressed state.

FIG. 14 illustrates a state in which the plunger 40 is located at a bottom dead center while the high-pressure pump 1 is attached to the internal combustion engine. In this state, a distance H1 between the large diameter portion 74 and the end face of the holder 60 facing the cylinder 10 is larger than a distance in which the plunger 40 reciprocates. In other words, even when the plunger 40 is located at the top dead center, the large diameter portion 74 comes out of contact with a fuel seal 51.

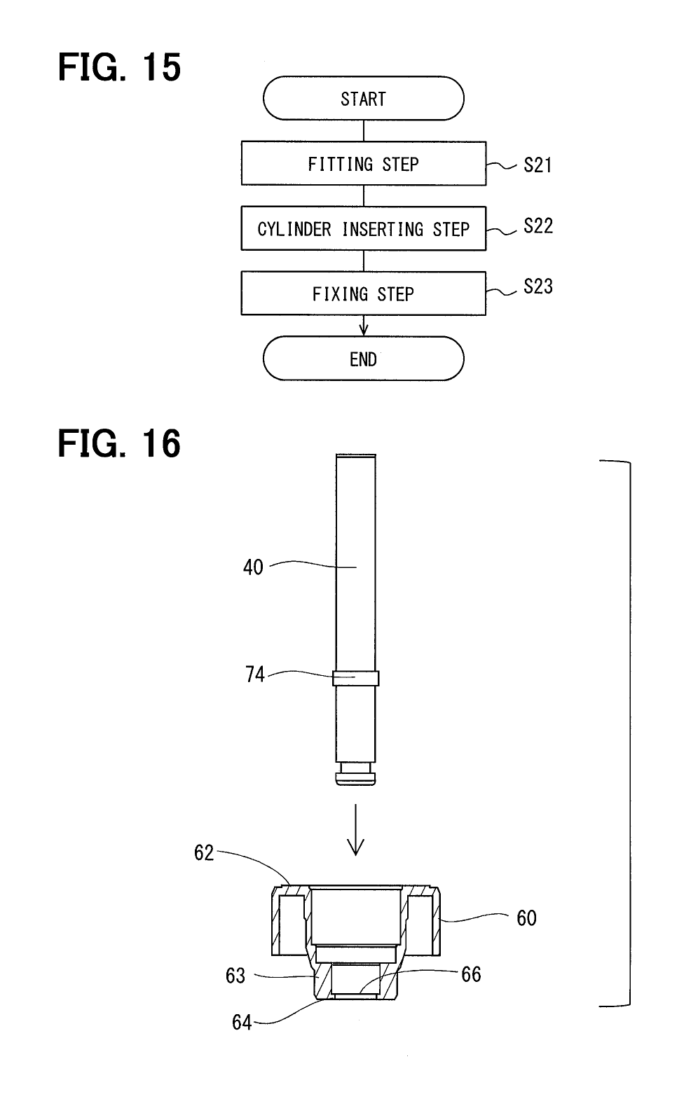

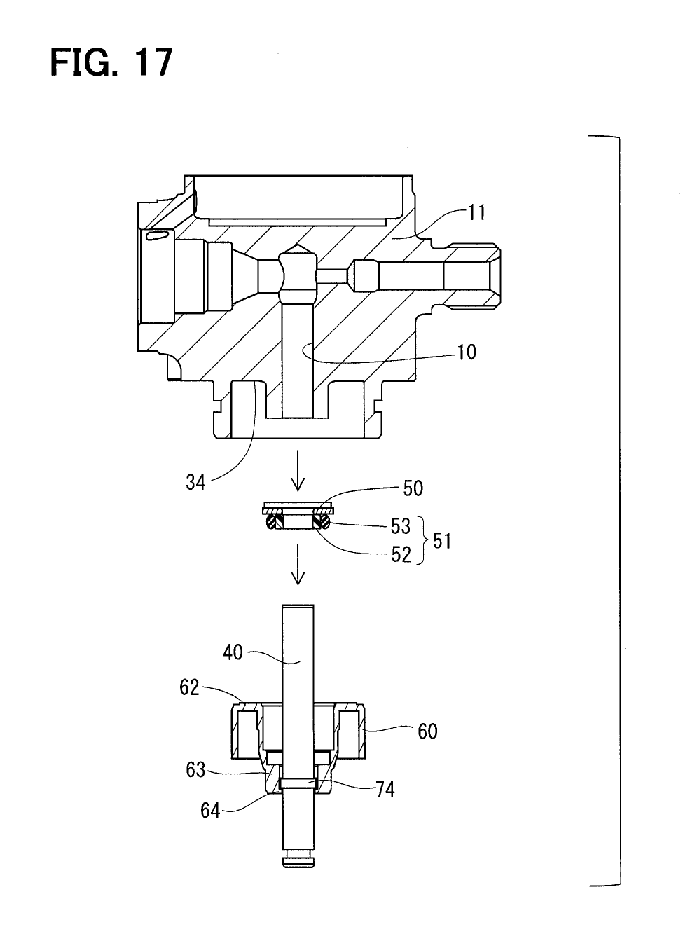

Next, a method of manufacturing the high-pressure pump 1 according to the third embodiment will be described with reference to FIGS. 15 to 17. First, in a fitting step of Step 21, as indicated by an arrow in FIG. 16, the plunger 40 is inserted into the holder 60 from the side of the holder 60 opposite to the small tubular portion 64. In this situation, the large diameter portion 74 of the plunger 40 is fitted on the inner side of the large tubular portion 63 of the holder 60. Next, in a cylinder inserting step of Step 22, after the fuel seal 51 and a spacer 50 have been inserted into the plunger 40 as indicated by an arrow in FIG. 17, the plunger 40 is inserted into the cylinder 10. In this situation, a spring receiving portion 62 of the holder 60 is fitted into a concave portion 34 of a pump body 11 by press fitting or the like. Subsequently, in a fixing step of Step 23, the pump body 11 and the spring receiving portion 62 of the holder 60 are fixed to each other by welding or the like. Thereafter, the high-pressure pump 1 is attached to a bore 3 formed in the engine block 2 of the internal combustion engine.

The high-pressure pump 1 according to the third embodiment has the following operational effects. (1) In the third embodiment, the large tubular portion 63 has an even inner diameter from the small tubular portion 64 to the cylinder 10, and the space 65 on the inner side of the large tubular portion 63 is open toward the cylinder 10. As a result, the large diameter portion 74 of the plunger 40 can be fitted to the inner side of the large tubular portion 63 from the cylinder 10 side of the holder 60 at a stage before the holder 60 is attached to the pump body 11.

(2) In the third embodiment, the large diameter portion 74 is integrally formed with the plunger 40 on the outer wall of the plunger 40. As a result, the number of components of the high-pressure pump 1 can be reduced.

(3) In the third embodiment, the method of manufacturing the high-pressure pump 1 includes the fitting step (S21), the cylinder inserting step (S22), and the fixing step (S23) described above. Accordingly, the large diameter portion 74 can be installed on the inner side of the large tubular portion 63 of the holder 60 without the use of a jig or the like.

### Fourth Embodiment

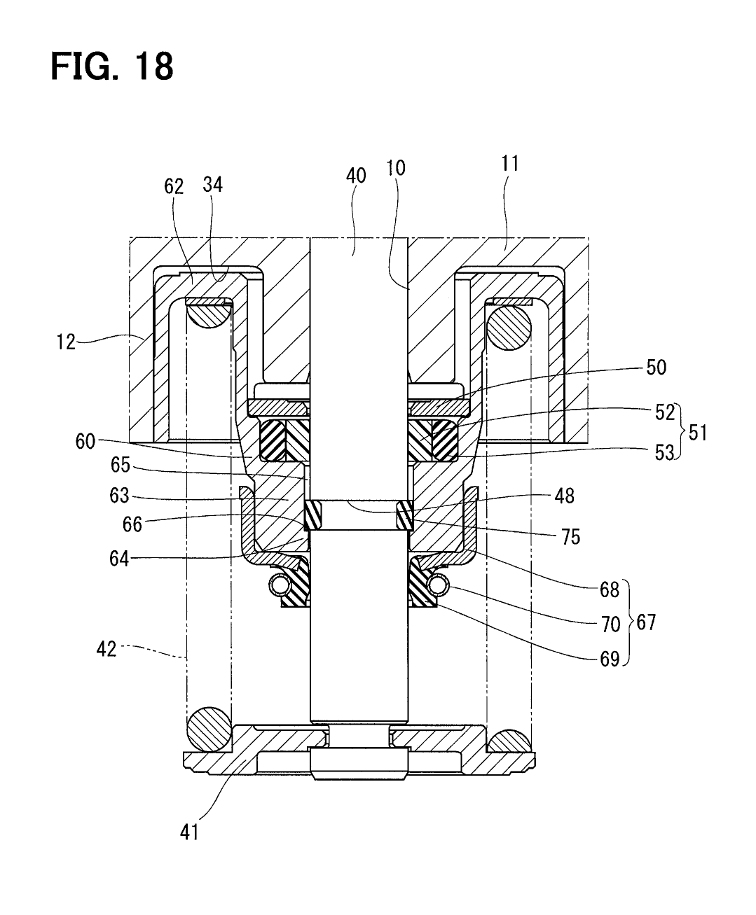

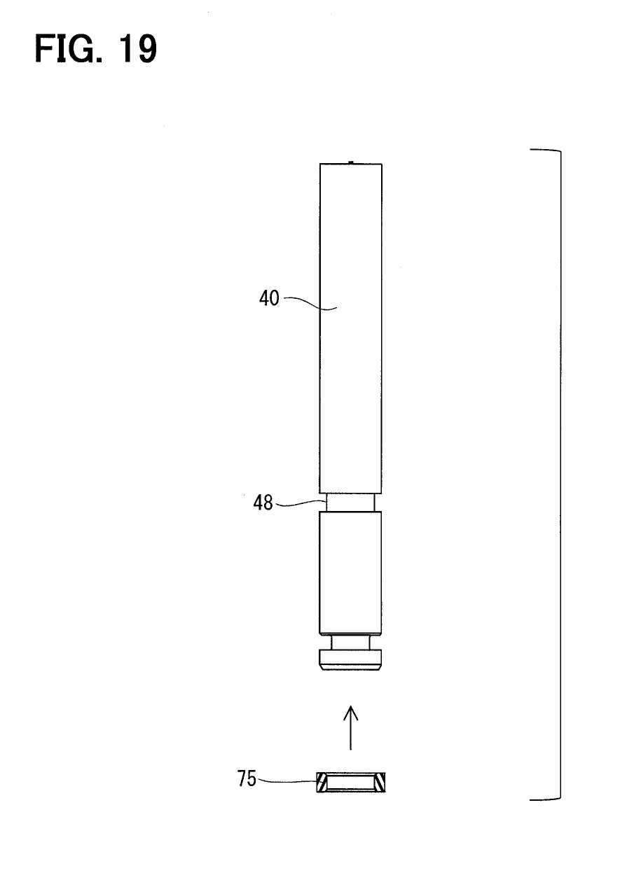

A fourth embodiment according to the present disclosure will be described below with reference to FIGS. 18 and 19. In the fourth embodiment, a plunger 40 has an annular groove 48 at a position corresponding to a large tubular portion 63 of a holder 60. An annular elastic ring 75 is disposed on the outer side of the annular groove 48. The elastic ring 75 is made of rubber or elastomer, for example, and comes in sliding contact with an inner wall of the large tubular portion 63 in a liquid-tight manner. The elastic ring 75 according to the present embodiment corresponds to an example of the above-mentioned locking member.

In a state of a high-pressure pump 1 before being attached to an internal combustion engine, the elastic ring 75 is locked to a stepped surface 66 between the large tubular portion 63 and a small tubular portion 64. For that reason, the plunger 40 is prevented from falling out of a cylinder 10, and a plunger spring 42 is held in a compressed state.

The elastic ring 75 can expand and contract in a circumferential direction. For that reason, as indicated by an arrow in FIG. 19, the elastic ring 75 can be attached to a fitting groove of the plunger 40 from an axial direction of the plunger 40.

In the fourth embodiment, the elastic ring 75 is fitted into the annular groove 48 provided in an outer wall of the plunger 40. With this configuration, since there is no need to provide a portion protruding on the outer wall of the plunger 40, the plunger 40 can be continuously polished in the axial direction. Therefore, the manufacturing process of the plunger 40 can be simplified. Furthermore, in the fourth embodiment, the elastic ring 75 and the inner wall of the large tubular portion 63 are in liquid-tight sliding contact with each other, thereby being capable of preventing leakage of a fuel from a gap between the cylinder 10 and the plunger 40 to the outside, and also preventing an oil from infiltrating from the outside into the gap.

In the multiple embodiments described above, the high-pressure pump 1 in which the opposite side of the pressurizing chamber 15 from the plunger 40 is closed by the pump body 11 has been described. In the high-pressure pump 1, the intake valve unit 20, the discharge valve unit 29, or the like may be detachably attached on a side of the pressurizing chamber 15 opposite to the plunger 40.

The present disclosure is not limited to the above-described multiple embodiments. In addition to combinations of the above-described embodiments, the present disclosure can be embodied in various forms within a scope not departing from the spirit of the invention.

While the present disclosure has been described with reference to embodiments thereof, it is to be understood that the disclosure is not limited to the embodiments and constructions. To the contrary, the present disclosure is intended to cover various modification and equivalent arrangements. In addition, while the various elements are shown in various combinations and configurations, which are exemplary, other combinations and configurations, including more, less or only a single element, are also within the spirit and scope of the present disclosure.

1. A high-pressure pump comprising:
a cylinder;
a pump body that includes a pressurizing chamber provided in an end portion of the cylinder;
a plunger that is disposed reciprocatably on an inner side of the cylinder and is capable of changing a volume of the pressurizing chamber;
a cylindrical member that is disposed coaxially with the cylinder on an opposite side of the cylinder from the pressurizing chamber, and the cylindrical member including a large tubular portion which defines a predetermined space between the large tubular portion and an outer wall of the plunger, and a small tubular portion having an inner diameter smaller than an inner diameter of the large tubular portion and being located on an opposite side of the large tubular portion from the cylinder; and
a locking member protruding radially outward from the outer wall of the plunger at a position corresponding to the large tubular portion of the cylindrical member, the locking member being accommodated in the space on an inner side of the large tubular portion.

2. The high-pressure pump according to claim 1, wherein
the cylinder and the pump body are integrated together, and
the pump body closes an opposite side of the pressurizing chamber from the plunger.

3. The high-pressure pump according to claim 1, wherein
the locking member is capable of being housed within a hole or a groove provided on the outer wall of the plunger, and the locking member protrudes radially outward from the outer wall of the plunger by an urging force.

4. The high-pressure pump according to claim 3, wherein
the blocking member includes:
a pin that is accommodated in the hole provided on the outer wall of the plunger; and
an urging device urging the pin from the hole of the plunger toward the large tubular portion of the cylindrical member.

5. The high-pressure pump according to claim 3, wherein
the locking member is an arc-shaped elastic member capable of being housed within the groove which has an annular shape and is provided on the outer wall of the plunger.

6. The high-pressure pump according to claim 1, further comprising:
a sealing member having an annular shape and being provided on a radially outer side of a part of the plunger that is located on an opposite side of the cylindrical member from the cylinder; and
a second urging device having an annular shape and urging the sealing member radially inward, wherein
the plunger has a groove portion into which the sealing member can be fitted before the pump body is installed in the internal combustion engine.

7. The high-pressure pump according to claim 1, wherein
the large tubular portion has an even inner diameter from the small tubular portion to the cylinder, and the space on the inner side of the large tubular portion is open toward the cylinder.

8. The high-pressure pump according to claim 7, wherein
the locking member is a large diameter portion integrated with the plunger on the outer wall of the plunger.

9. The high-pressure pump according to claim 7, wherein
the locking member is an annular elastic ring that is fitted in an annular groove provided on the outer wall of the plunger.

10. A method for manufacturing the high-pressure pump according to claim 1, comprising:
a step of placing the plunger on an inner side of a cylindrical jig, and placing the locking member within a hole or a groove provided on the outer wall of the plunger;
a step of inserting the jig into the large tubular portion of the cylindrical member; and
a step of detaching the jig from the plunger, and protruding the locking member from the outer wall of the plunger toward the large tubular portion of the cylindrical member.

11. A method for manufacturing the high-pressure pump according to claim 7, comprising:
a step of fitting the locking member into a space inside the large tubular portion in a direction from an opposite side of the cylindrical member from the small tubular portion;
a step of inserting the plunger into the cylinder; and
a step of fixing the cylindrical member to the pump body.
